(19) United States
(12) Patent Application Publication
(10) Pub. No.: US 2022/0155004 A1
(43) Pub. Date: May 19, 2022

(54) ROTATING ORGANIZATIONAL BIN FOR A REFRIGERATOR APPLIANCE

(71) Applicant: Haier US Appliance Solutions, Inc., Wilmington, DE (US)

(72) Inventors: Bharath Gada, Telangana (IN); Abhiruth Mohan, Kerala (IN)

(21) Appl. No.: 17/098,879

(22) Filed: Nov. 16, 2020

(51) Int. Cl. F25D 23/04; F25D 13/02; F25D 25/00; F25D 29/00

(52) U.S. Cl. CPC F25D 23/04; F25D 13/02; F16H 27/06; F25D 29/003; F25D 29/005; F25D 25/005

(57) ABSTRACT

A storage bin assembly includes a bin frame, a shaft mounted to the bin frame and being rotatable about an axis of rotation, a storage bin coupled to the shaft, the storage bin comprising a plurality of pockets spaced apart along the axis of rotation, and a bin door pivotally coupled to the storage bin to open and close the plurality of pockets.

### FIELD OF THE INVENTION

The present subject matter relates generally to refrigerator appliances, and more particularly to modular storage bins for refrigerator appliances.

### BACKGROUND OF THE INVENTION

Refrigerator appliances generally include a cabinet that defines a chilled chamber. A wide variety of items, such as food items, medications, and the like maybe stored in the chilled chamber. In particular, routine and cyclical use items such as medications may be stored in easily accessible locations within the refrigerator appliance for quick access.

However, some items may only be required on certain days, or some items may be personal to only certain individuals. For instance, controlled substances may be stored in the refrigerator appliance for use or consumption only by specified users. Additionally or alternatively, weekly use items (i.e., items only required on certain days) may be stored in the refrigerator appliance.

Accordingly, a refrigerator having features that improve the storage and release of items would be beneficial. More specifically, a storage bin with improved security or timing features would be particularly beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a storage bin assembly for an appliance is provided. The appliance may include a cabinet having a receiving space and a cabinet door to open and close the cabinet. The storage bin assembly may include a bin frame, a shaft mounted to the bin frame and being rotatable about an axis of rotation, a storage bin coupled to the shaft, the storage bin comprising a plurality of pockets spaced apart along the axis of rotation, and a bin door pivotally coupled to the storage bin to open and close the plurality of pockets.

In another exemplary aspect of the present disclosure, a refrigerator appliance is provided. The refrigerator appliance may include a cabinet defining a fresh food chamber, a cabinet door pivotally connected to the cabinet to open and close the cabinet, and a storage bin assembly. The storage bin assembly may include a bin frame, a shaft mounted to the bin frame and being rotatable about an axis of rotation, a storage bin coupled to the shaft, the storage bin comprising a plurality of pockets spaced apart along the axis of rotation, and a bin door pivotally coupled to the storage bin to open and close the plurality of pockets.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present disclosure.

FIG. 2 provides a perspective view of the refrigerator appliance of FIG. 1.

FIG. 3 provides a front view of the refrigerator appliance of FIG. 1 with doors in an open position.

FIG. 4 provides a perspective view of a storage bin assembly according to an exemplary embodiment of the present disclosure, with a bin door in an open position.

FIG. 5 provides a perspective view of the exemplary storage bin assembly of FIG. 4 with the frame removed.

FIG. 6 provides a perspective view of a shaft of the exemplary storage bin assembly of FIG. 5 with individual storage bins removed.

FIG. 7 provides a perspective view of an individual storage bin of the exemplary storage bin assembly of FIG. 5.

FIG. 8 provides a side view of the exemplary individual storage bin of FIG. 7.

FIG. 9 provides a perspective view of a gearing assembly according to an exemplary embodiment of the present disclosure.

FIG. 10 provides a schematic illustration of an exemplary refrigerator appliance in communication with a remote user interface device according to one or more embodiments of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

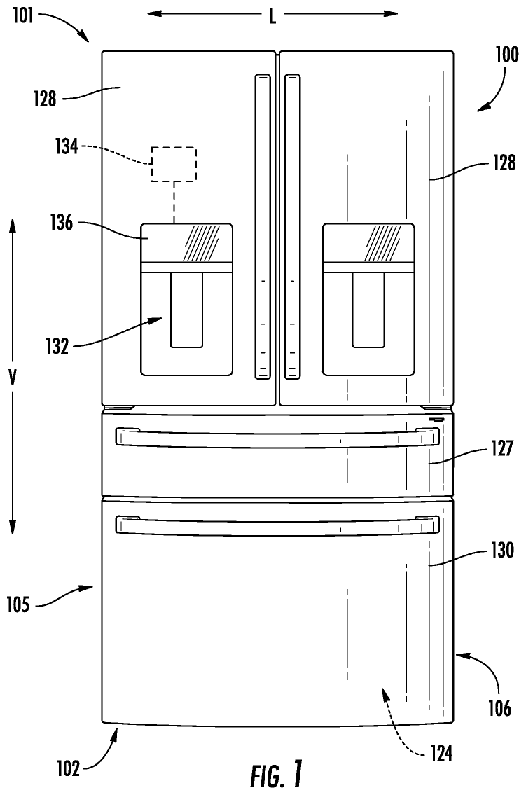

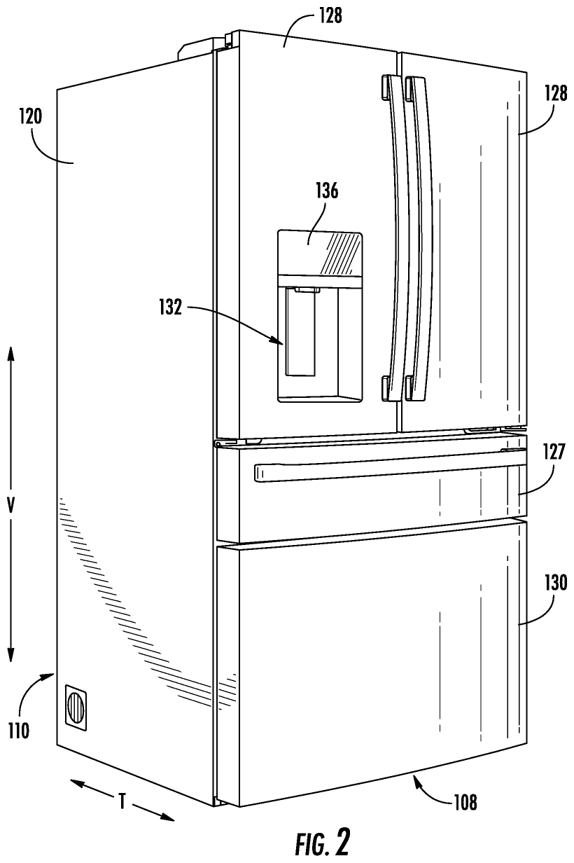

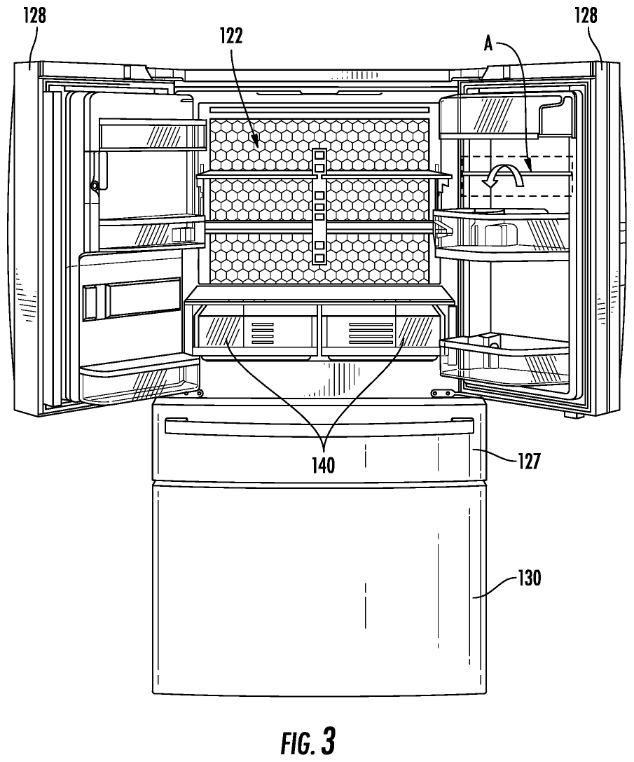

FIG. 1 is a front view of an exemplary embodiment of a refrigerator appliance 100. FIG. 2 is a perspective view of the refrigerator appliance 100. FIG. 3 is a front view of the refrigerator appliance 100 with fresh food doors 128 thereof in an open position. Refrigerator appliance 100 extends between a top 101 and a bottom 102 along a vertical direction V. Refrigerator appliance 100 also extends between a first side 105 and a second side 106 along a lateral direction L. As shown in FIG. 2, a transverse direction T may additionally be defined perpendicular to the vertical and lateral directions V, L. Refrigerator appliance 100 extends along the transverse direction T between a front portion 108 and a back portion 110.

Refrigerator appliance 100 may include a cabinet or housing 120 defining an upper fresh food chamber 122 (FIG. 3) and a lower freezer chamber or frozen food storage chamber 124 arranged below the fresh food chamber 122 along the vertical direction V. An auxiliary food storage chamber may be positioned between the fresh food storage chamber 122 and the frozen food storage chamber 124, e.g., along the vertical direction V. Because the frozen food storage chamber 124 is positioned below the fresh food storage chamber 122, refrigerator appliance 100 may be generally referred to as a bottom mount refrigerator. In the exemplary embodiment, housing 120 may also define a mechanical compartment (not shown) for receipt of a sealed cooling system (not shown). Using the teachings disclosed herein, one of skill in the art will understand that the present technology can be used with other types of refrigerators (e.g., side-by-side) or a freezer appliance as well. Consequently, the description set forth herein is for illustrative purposes only and is not intended to limit the technology in any aspect.

Refrigerator doors 128 may each be rotatably hinged to an edge of housing 120 for accessing fresh food chamber 122. It should be noted that while two doors 128 in a “French door” configuration are illustrated, any suitable arrangement of doors utilizing one, two or more doors is within the scope and spirit of the present disclosure. A freezer door 130 may be arranged below refrigerator doors 128 for accessing freezer chamber 124. In the exemplary embodiment, freezer door 130 is coupled to a freezer drawer (not shown) slidably mounted within freezer chamber 124. An auxiliary door 127 may be coupled to an auxiliary drawer which may be slidably mounted within the auxiliary chamber.

Operation of the refrigerator appliance 100 can be regulated by a controller 134 that is operatively coupled to a user interface panel 136. User interface panel 136 may provide selections for user manipulation of the operation of refrigerator appliance 100 to modify environmental conditions therein, such as temperature selections, etc. In some embodiments, user interface panel 136 may be proximate a dispenser assembly 132. In response to user manipulation of the user interface panel 136, the controller 134 may operate various components of the refrigerator appliance 100. Operation of the refrigerator appliance 100 may be regulated by the controller 134, e.g., controller 134 may regulate operation of various components of the refrigerator appliance 100 in response to programming and/or user manipulation of the user interface panel 136.

The controller 134 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controllers 134 as disclosed herein are capable of and may be operable to perform any methods and associated method steps as disclosed herein.

The controller 134 may be positioned in a variety of locations throughout refrigerator appliance 100. In the illustrated embodiment, the controller 134 is located within the door 128. In such an embodiment, input/output (“I/O”) signals may be routed between the controller and various operational components of refrigerator appliance 100. In one embodiment, the user interface panel 136 represents a general purpose I/O (“GPIO”) device or functional block. In one embodiment, the user interface 136 includes input components, such as one or more of a variety of electrical, mechanical or electro-mechanical input devices including rotary dials, push buttons, and touch pads. The user interface 136 may include a display component, such as a digital or analog display device designed to provide operational feedback to a user. For example, the user interface 136 may include a touchscreen providing both input and display functionality. The user interface 136 may be in communication with the controller via one or more signal lines or shared communication busses.

Using the teachings disclosed herein, one of skill in the art will understand that the present subject matter can be used with other types of refrigerators such as a refrigerator/freezer combination, side-by-side, bottom mount, compact, and any other style or model of refrigerator appliance. Accordingly, other configurations of refrigerator appliance 100 could be provided, it being understood that the configurations shown in the accompanying FIGS. and the description set forth herein are by way of example for illustrative purposes only.

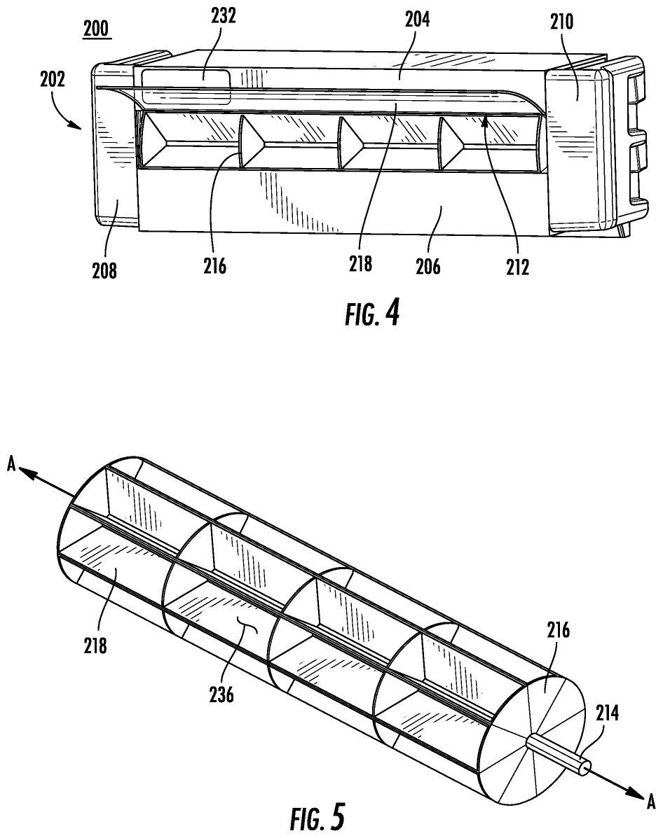

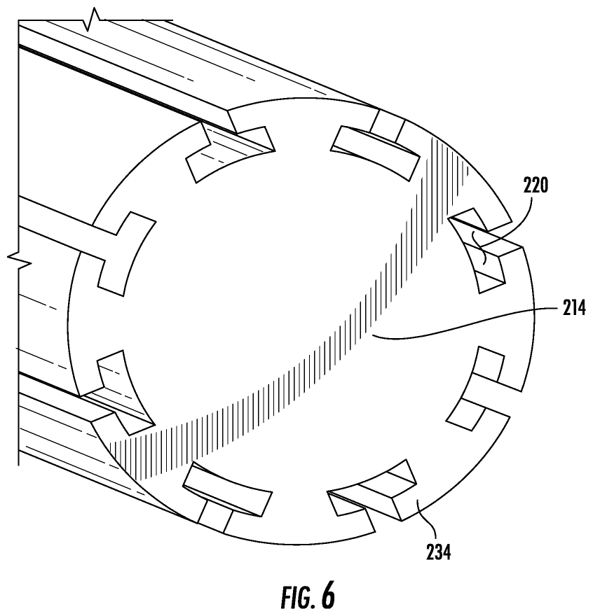

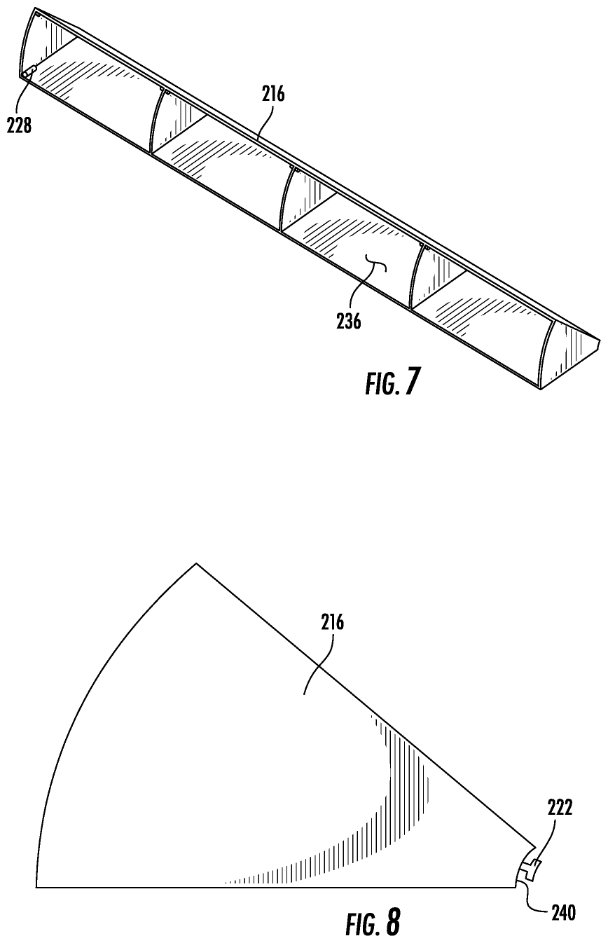

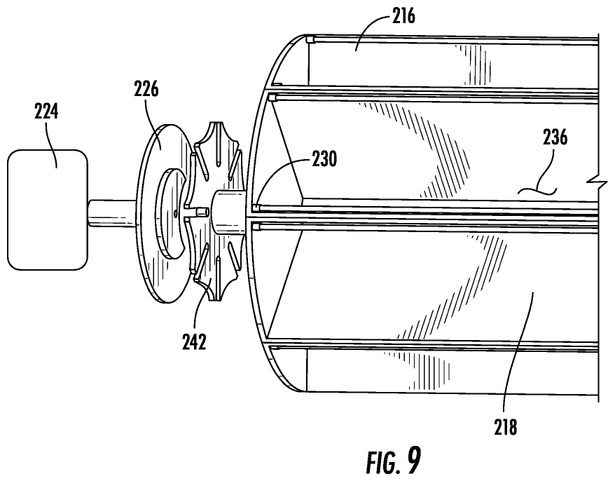

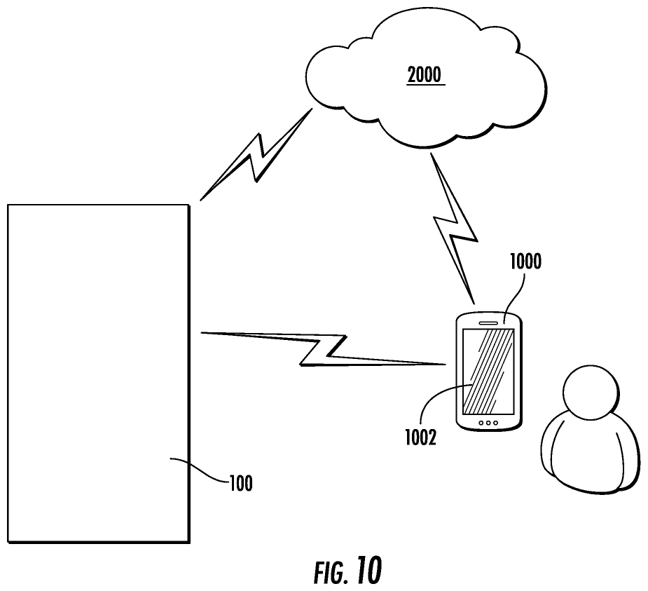

FIG. 4 provides a perspective view of a storage bin assembly according to an exemplary embodiment with a bin door in an open position. FIG. 5 provides a perspective view of the exemplary storage bin assembly of FIG. 4 with the frame removed. FIG. 6 provides a perspective view of a shaft of the exemplary storage bin assembly of FIG. 5 with individual storage bins removed. FIG. 7 provides a perspective view of an individual storage bin of the exemplary storage bin assembly of FIG. 5. FIG. 8 provides a side view of the exemplary individual storage bin of FIG. 7. FIG. 9 provides a perspective view of a gearing assembly according to an exemplary embodiment of the present disclosure.

Referring now generally to FIGS. 4-9, refrigerator appliance 100 may include a storage bin assembly 200. Storage bin assembly 200 may be a modular assembly that may be removably attached to an interior of refrigerator appliance 100 (e.g., in fresh food chamber 122 or frozen food chamber 124). In some embodiments, storage bin assembly 200 is removably attached to an interior of refrigerator door 128. The modularity of storage bin assembly 200 allows for easy removal and relocation of storage bin assembly 200 throughout different locations of refrigerator appliance 100, or between two different refrigerators, or between two different appliances.

Storage bin assembly 200 may include a bin frame 202. Bin frame 202 may rotatably support a plurality of storage bins 216 through a shaft 214 (described in detail below). Bin frame 202 may include a top frame member 204 and a bottom frame member 206. Bin frame 202 may further include a first side frame member 208 and a second side frame member 210 opposite the first side frame member 208. The first and second side frame members 208 and 210 may include features allowing storage bin assembly 200 to be removably coupled to refrigerator appliance 100. For example, side frame members 208 and 210 may include grooves formed on each respective outer surface configured to interconnect with tabs or ledges formed, for example, in door 128 of refrigerator appliance 100. One sample location of storage bin assembly 100 is shown in phantom lines in FIG. 3. Further, the plurality of storage bins 216 may rotate about a horizontal axis A, shown in FIG. 3.

Top frame member 204 and bottom frame member 206 may be positioned such that a single storage bin 216 is visible at one time. In other words, top frame member 204 and bottom frame member 206 may collectively define a slot 212 through which storage bin 216 is accessible. Accordingly, in some embodiments, top frame member 204 and bottom frame member 206 are a single integral piece. In some embodiments, top frame member 204 is a separate piece from bottom frame member 206. In such an example, top frame member 204 and bottom frame member 206 may be fastened together (e.g., at a rear side of bin frame 202 opposite slot 212). For example, top frame member 204 and bottom frame member 206 may be fastened together via a bolt or screw, a snap fit, an adhesive, or the like. First side frame member 208 and second side frame member 210 may be attached at lateral sides of top frame member 204 and bottom frame member 206. Accordingly, top frame member 204, bottom frame member 206, first side frame member 208, and second side frame member 210 may collectively define a compartment in which the plurality of storage bins 216 may be housed.

Storage bin assembly 200 may include a shaft 214 mounted to bin frame 202. Shaft 214 may be rotatable about axis of rotation A. As discussed previously, axis of rotation A may be orientated in the horizontal direction (i.e., in the lateral direction L when refrigerator door 128 is in a closed position). However, in some embodiments, axis of rotation A may be orientated in the vertical direction V. Shaft 214 may include a plurality of grooves 220 defined therein. Grooves 220 may be spaced apart circumferentially around shaft 214 in an equidistant manner. Any reasonable number of grooves 220 may be formed. In one example, eight grooves 220 are formed in shaft 214. Grooves 220 may be defined radially inward from an outer circumferential surface of shaft 214. Grooves 220 may extend an axial length of shaft 214. In detail grooves 220 may extend axially from a first end of shaft 214 to a second end of shaft 214 such that each groove 220 is exposed through the first end and the second end of shaft 214. In some embodiments, grooves 220 may extend to a predetermined distance through shaft 214, such that only one end of grooves 220 is exposed through the first end of shaft 214. In other words, grooves 220 may have a blind end defined axially down shaft 214. Grooves 220 may further define a restraint feature formed at a radially inward portion of groove 220. For example, each groove 220 may be defined in part by a retention flange 234 to form an undercut portion that extends circumferentially. In detail, each groove 220 may have a “T” shaped cross-section. However, grooves 220 may have any suitable cross-section, such as a wedge-shape cross-section, a circular cross-section, or the like.

Shaft 214 may be rotatably mounted within bin frame 202. For example, bin frame 202 may include one or more bearings (not shown) on which shaft may be mounted. In some embodiments, a first bearing is attached to first side frame member 208 and a second bearing is attached to second side frame member 210. Additionally or alternatively, the first bearing may be formed integrally (e.g., as one piece) with first side frame member 208 and the second bearing may be formed integrally (e.g., as one piece) with second side frame member 210. Additionally or alternatively, the first and second bearings may be attached to one or both of top frame member 204 and bottom frame member 206.

Storage bin assembly 200 may include a storage bin 216. In detail, storage bin assembly 200 may include a plurality of storage bins 216. Storage bin 216 may be removably attached to shaft 214. Storage bin 216 may include a plurality of pockets 236 defined therein. For example, pockets 236 may be spaced apart along the axis of rotation A of shaft 214 (i.e., axially). Any reasonable number of pockets 236 may be defined, for example three pockets 236, for example four pockets 236, for example six pockets 236, etc. Each of the pockets 236 may have an identical size. Additionally or alternatively, each pocket 236 may have a different size. Storage bin 216 may have a wedge-shaped cross-section. Accordingly, the plurality of storage bins 216 may be arranged circumferentially about shaft 214.

Storage bin 216 may include a protrusion 222 extending from a base 240 of storage bin 216. In detail, protrusion 222 may have a “T” shaped cross-section along the direction of the axis of rotation A (i.e., axially). Protrusion 222 may correspond to groove 220 in shaft 214. In other words, protrusion 222 may be complementary to groove 220. Accordingly, protrusion 222 may slide into groove 220 in the axial direction A so as to attach storage bin 216 to shaft 214.

Storage bin assembly 200 may include a bin door 218. Bin door 218 may be coupled to storage bin 216 to open and close the plurality of pockets 236. In detail, bin door 218 may be pivotally coupled to storage bin 216. In other words, bin door 218 may pivot about an axis parallel to the axis of rotation A of shaft 214. Accordingly, bin door 218 may rotate with respect to storage bin 216 to provide selective access to pockets 236. One or more bin doors 218 may be pivotally attached to each storage bin 216. For example, one individual bin door 218 may be provided for each individual pocket 236. In other words, a plurality of doors 218 may be attached to storage bin 216, and each door 218 may provide access to a single pocket 236. Additionally or alternatively, a single bin door 218 may provide selective access to all pockets 236 on storage bin 216. For another example, in FIG. 4, a single door 218 is shown in an open position.

Storage bin assembly 200 may include a latching mechanism between bin door 218 and storage bin 216. For instance, latching mechanism may include a first magnet 228 and a second magnet 230. First magnet 228 may be positioned within and attached to a pocket 236 of storage bin 216. First magnet 228 may be positioned at a corner of pocket 236 opposite the axis of rotation of bin door 218. First magnet may be a push magnet configured to latch and release by pushing bin door 218 inward. Second magnet 230 may be attached to bin door 218. Second magnet 230 may be correspond to first magnet 228 such that first magnet 228 and second magnet 230 are magnetically coupled when bin door 218 is in a closed position (i.e., covering pockets 236).

Storage bin assembly 200 may include a driving mechanism. The driving mechanism may drive a rotation of shaft 214. The driving mechanism may include a motor 224. Motor 224 may be provided within bin frame 202. For instance, motor 224 may be attached to first side frame member 208. The location of motor 224 is not limited, however. Motor 224 may be a stepper motor. Additionally or alternatively, motor 224 may be a brushless direct current (DC) motor. The driving mechanism may include a driving gear 226 and a driven gear 242. Driving gear 226 may be rotated by motor 224 during an operation of motor 224. Driven gear 242 may be connected to shaft 214. For instance, driven gear 242 may be connected to shaft 214 via a pin connection. In some embodiments, driven gear 242 is integrally formed with shaft 214.

Driving gear 226 and driven gear 242 may be meshed such that a rotation of driving gear 226 in turn rotates driven gear 242. Accordingly, shaft 214 may rotate according to a rotation of motor 224. In the case where motor 224 is a stepper motor, motor 224 may rotate according to a predetermined schedule. In detail, a user may set motor 224 to rotate a predetermined amount on a regular schedule (e.g., daily, weekly, etc.). The predetermined amount to which motor rotates may correspond to a single storage bin 216. In other words, a user may set a schedule such that motor 224 rotates a predetermined arc length every twenty-four hours. The arc length may correspond to an arc length of storage bin 216. Thus, every twenty-four hours, a different storage bin 216 is accessible within bin frame 202. The driving mechanism may be a clock mechanism. In other words, driven gear 242 may be a Geneva gear.

Storage bin assembly 200 may further include a display screen 232. Display screen 232 may be attached to bin frame 202. For instance, display screen 232 may be attached to top frame member 204. Additionally or alternatively, display screen 232 may be attached to bin door 218. Display screen 232 may display information relating to the contents of storage bin 216 or a specific user to whom a particular storage bin 216 is associated. Display screen 232 may communicate with controller 134 and user interface panel 136. Thus, information displayed on display screen 232 may be customized by a user via user interface panel 136.

FIG. 10 schematically illustrates the refrigerator appliance 100 communicating with a remote user interface device 1000. Also shown (but not numbered) in FIG. 10 is a user such as may interact with the remote user interface device 1000, e.g., via a user interface 1002 of the remote user interface such as a touchscreen in the illustrated embodiment. For example, the remote user interface device 1000 may be a hand-held device, such as a cell phone or smart phone or any similar device, in operative communication with the controller 134 via a wireless connection. As shown in FIG. 10, the refrigerator appliance 100, and in particular, controller 134 thereof, may be configured to communicate with a separate device external to the appliance, such as a communications device or other remote user interface device 1000. The remote user interface device 1000 may be a laptop computer, smartphone, tablet, personal computer, wearable device, smart home system, and/or various other suitable devices. The refrigerator appliance 100 may include a network communication module, e.g., a wireless communication module, for communicating with the remote user interface device 1000. In various embodiments, a network communication module may include a network interface such that the controller 134 of the refrigerator appliance 100 can connect to and communicate over one or more networks with one or more network nodes. A network communication module may also include one or more transmitting, receiving, or transceiving components for transmitting/receiving communications with other devices communicatively coupled with refrigerator appliance 100. The network communication module may be in communication with, e.g., coupled or connected to, the controller 134 to transmit signals to and receive signals from the controller 134.

As schematically illustrated in FIG. 10, the refrigerator appliance 100 may be configured to communicate with the remote user interface device 1000 either directly or through a network 2000. Thus, in various embodiments, the refrigerator appliance 100 and the remote user interface 1000 may be configured to communicate wirelessly with each other and/or with the network 2000. The network 2000 may be or include various possible communication connections and interfaces, e.g., such as Zigbee, BLUETOOTH®, WI-FI®, or any other suitable communication connection. The remote user interface device 1000 may include a memory for storing and retrieving programming instructions. For example, the remote user interface device 1000 may be a smartphone operable to store and run applications, also known as “apps,” and may include a remote user interface provided as a smartphone app.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A storage bin assembly for an appliance, the appliance comprising a cabinet having a receiving space and a cabinet door to open and close the cabinet; the storage bin assembly comprising:
a bin frame;
a shaft mounted to the bin frame and being rotatable about an axis of rotation;
a storage bin coupled to the shaft, the storage bin comprising a plurality of pockets spaced apart along the axis of rotation; and
a bin door pivotally coupled to the storage bin to open and close the plurality of pocket, wherein the bin door pivots about a pivot axis, the pivot axis being parallel to the axis of rotation of the shaft.

2. The storage bin assembly of claim 1, wherein the shaft defines a plurality of grooves spaced circumferentially about the shaft and extending along an entire axial length of the shaft, and wherein the storage bin is removably coupled to the shaft via one of the plurality of grooves.

3. The storage bin assembly of claim 2, wherein the storage bin comprises a plurality of storage bins arranged circumferentially around the shaft.

4. The storage bin assembly of claim 3, wherein each of the plurality of storage bins comprises a protrusion, each protrusion being complementary to a separate groove of the plurality of grooves.

5. The storage bin assembly of claim 4, wherein the bin frame comprises a top frame member and a bottom frame member positioned such that only one storage bin is accessible at a time.

6. The storage bin assembly of claim 1, further comprising:
a motor provided in the bin frame; and
a gear attached to the shaft and operably coupled to the motor, wherein the motor is configured to rotate the shaft by a predetermined increment at regular intervals.

7. The storage bin assembly of claim 6, wherein the motor is a stepper motor or a brushless direct current motor, and wherein the gear is a Geneva driven gear.

8. The storage bin assembly of claim 1, further comprising:
a first magnet attached to the storage bin; and
a second magnet attached to the bin door and magnetically coupled to the first magnet.

9. The storage bin assembly of claim 1, further comprising a display screen attached to the bin frame.

10. The storage bin assembly of claim 1, wherein the bin frame is configured to be removably coupled to the cabinet door.

11. A refrigerator appliance, comprising:
a cabinet defining a fresh food chamber;
a cabinet door pivotally connected to the cabinet to open and close the cabinet; and
a storage bin assembly, wherein the storage bin assembly comprises:
a bin frame;
a shaft mounted to the bin frame and being rotatable about an axis of rotation, the shaft comprising a plurality of grooves formed radially into the shaft, the plurality of grooves being spaced circumferentially about the shaft and extending along an entire axial length of the shaft, wherein each of the plurality of grooves is defined in part by a retention flange that forms an undercut;
a storage bin coupled to the shaft, the storage bin comprising a plurality of pockets spaced apart along the axis of rotation; and
a bin door pivotally coupled to the storage bin to open and close the plurality of pockets.

12. The refrigerator appliance of claim 11, wherein the storage bin is removably coupled to the shaft via at least one of the plurality of grooves.

13. The refrigerator appliance of claim 12, wherein the storage bin comprises a plurality of storage bins arranged circumferentially around the shaft.

14. The refrigerator appliance of claim 13, wherein each of the plurality of storage bins comprises a protrusion, each protrusion being complementary to a groove of the plurality of grooves.

15. The refrigerator appliance of claim 14, wherein the bin frame comprises a top frame member and a bottom frame member positioned such that only one storage bin is accessible at a time.

16. The refrigerator appliance of claim 11, further comprising:
a motor provided in the bin frame; and
a gear attached to the shaft and operably coupled to the motor, wherein the motor is configured to rotate the shaft by a predetermined increment at regular intervals.

17. The refrigerator appliance of claim 16, wherein the motor is a stepper motor or a brushless direct current motor, and wherein the gear is a Geneva driven gear.

18. The refrigerator appliance of claim 11, further comprising:
a first magnet attached to the storage bin; and
a second magnet attached to the bin door and magnetically coupled to the first magnet.

19. The refrigerator appliance of claim 11, further comprising a display screen attached to the bin frame.

20. The refrigerator appliance of claim 11, wherein the storage bin assembly is removably coupled to an interior of the cabinet door.
